(19) United States
(12) Patent Application Publication
(10) Pub. No.: US 2026/0104517 A1
(43) Pub. Date: Apr. 16, 2026

(54) GLOBAL NAVIGATION SATELLITE SYSTEM (GNSS) CYCLE SLIP DETECTION AND CORRECTION

(71) Applicant: QUALCOMM Incorporated, San Diego, CA (US)

(72) Inventors: Yuxiang PENG, San Jose, CA (US); Ning LUO, Cupertino, CA (US)

(21) Appl. No.: 18/916,986

(22) Filed: Oct. 16, 2024

(51) Int. Cl. G01S 19/44

(52) U.S. Cl. CPC G01S 19/44

(57) ABSTRACT

Techniques to detect and correct for cycle slips in global navigation satellite system (GNSS) positioning may involve using measurements from a series of continuous GNSS epochs in which certain preliminary conditions are met. Embodiments comprise using a first set of rounded values for the integer ambiguity values corresponding to the float ambiguity values of the epochs in the series, then analyzing the first set of rounded values to determine final integer ambiguity values for the set of epochs. Embodiments can include determining the offset between the first set and a second set of rounded values and analyzing the offset to determine which set of rounded values to use as the final integer ambiguity values. Some embodiments comprise determining the most common rounded value for the float ambiguity values and analyzing whether one or more other rounded values are used.

### BACKGROUND

### 1. Field of Disclosure

The present disclosure relates generally to the field of mobile device positioning using radio frequency (RF) signals and, more specifically, to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously driven vehicle is in and may further benefit from sub-meter-level positioning information that enables it to determine where that vehicle is located within the lane.

Among other things, high-accuracy GNSS-based positioning uses carrier phase measurements of a satellite signal for which a number of cycles, or wavelengths, of the carrier frequency is determined. If a GNSS receiver loses a lock on the satellite signal, a jump or discontinuity in the number of cycles, known as a “cycle slip,” can occur. This can degrade the accuracy of the determined GNSS-based position.

### BRIEF SUMMARY

An example method of global navigation satellite system (GNSS) positioning of a GNSS device, according to this disclosure, may include determining that preliminary conditions are met for a set of epochs having a plurality of successive epochs having float ambiguity values for carrier phase measurements taken by the GNSS device, where the preliminary conditions may include: the set of epochs is a continuous series of epochs for which one or more time increments between epochs occur at an expected interval, and a single reference satellite is used by the GNSS device to determine the float ambiguity values of the set of epochs. The method may in addition include, responsive to determining the preliminary conditions are met, determining a first set of rounded values having one or more first rounded values for the float ambiguity values. The method may moreover include determining final integer ambiguity values for the set of epochs based at least in part on an analysis of the first set of rounded values for the set of epochs.

An example global navigation satellite system (GNSS) device, according to this disclosure, may include at least one GNSS receiver, at least one memory, and at least one processor communicatively coupled with the at least one GNSS receiver and at least one memory. The at least one processor may be configured to determine that preliminary conditions are met for a set of epochs having a plurality of successive epochs having float ambiguity values for carrier phase measurements taken using the at least one GNSS receiver, where the preliminary conditions may include the set of epochs is a continuous series of epochs for which one or more time increments between epochs occur at an expected interval, and a single reference satellite is used by the GNSS device to determine the float ambiguity values of the set of epochs. The at least one processor may be further configured to, responsive to determining the preliminary conditions are met, determine a first set of rounded values having one or more first rounded values for the float ambiguity values. The at least one processor may be further configured to determine final integer ambiguity values for the set of epochs based at least in part on an analysis of the first set of rounded values for the set of epochs.

An example device for global navigation satellite system (GNSS) positioning, according to this disclosure, comprises means for determining that preliminary conditions are met for a set of epochs having a plurality of successive epochs having float ambiguity values for carrier phase measurements taken by a GNSS device, where the preliminary conditions may include the set of epochs is a continuous series of epochs for which one or more time increments between epochs occur at an expected interval, and a single reference satellite is used by the GNSS device to determine the float ambiguity values of the set of epochs. The device may in addition include means for, responsive to determining the preliminary conditions are met, determining a first set of rounded values having one or more first rounded values for the float ambiguity values. The device may moreover include means for determining final integer ambiguity values for the set of epochs based at least in part on an analysis of the first set of rounded values for the set of epochs.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system that can be used to determine the position of a mobile device (e.g., a global navigation satellite system (GNSS) device), according to an embodiment.

FIG. 2 is a simplified diagram of a GNSS system, according to an embodiment.

FIG. 3 is a graph provided to help illustrate the problem of cycle slip.

FIG. 4 is a flow diagram of a process by which integer double difference (DD) carrier phase (CP) ambiguity may be determined, according to some embodiments.

FIG. 5 is a flow chart of an algorithm, referred to herein as “Algorithm 0,” for detecting and correcting cycle slips, according to an embodiment.

FIG. 6 is a flow chart of an algorithm, referred to herein as “Algorithm 1,” for detecting and correcting cycle slips, according to an embodiment.

FIG. 7 is a flow chart of an algorithm, referred to herein as “Algorithm 2,” for detecting and correcting cycle slips, according to an embodiment.

FIG. 8 is a flow chart of an algorithm, referred to herein as “Algorithm 3,” for detecting and correcting cycle slips, according to an embodiment.

FIG. 9 is a graph of experimental results of using Algorithm 3 on GNSS data, according to some embodiments.

FIG. 10 is a graph of experimental results of using Algorithm 1 on GNSS data, according to some embodiments.

FIG. 11 is a graph of experimental results of using Algorithm 2 on GNSS data, according to some embodiments.

FIG. 12 is a flow diagram of a method of GNSS positioning of a GNSS device, according to an embodiment.

FIG. 13 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. Further, a “GNSS device” as used herein, may refer to an electronic device (e.g., mobile device or UE as described above) with circuitry and/or components capable of performing GNSS measurements and determining a GNSS position. As referred to herein, a “GNSS receiver” may refer to such circuitry and/or components or may generically refer to a GNSS device. According to some embodiments, a GNSS device comprising a mobile device and/or UE may be capable of sending and/or receiving data over a wireless communications network. Such a device may be stationary (e.g., permanently or temporarily) or mobile, and may communicate with a Radio Access Network (RAN). Generally put, communication by devices herein may be performed via a cellular network (e.g., via a core network via a RAN, and through the core network). The cellular network may be connected with external networks (such as the Internet) and with other devices. Other mechanisms of connecting to the Internet and/or other data networks are also possible for the devices described herein, such as over wireless local area network (WLAN) networks (e.g., based on the Institute of Electrical and Electronics Engineers (IEEE) 802.11 standard, etc.), and/or the like.

A “space vehicle” (SV) as referred to herein, relates to an object that is capable of transmitting signals to receivers (e.g., GNSS receivers/GNSS devices) on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, using carrier phase measurements, a GNSS device may determine a high-precision GNSS-based position. As part of the positioning solution, the GNSS device may determine a number of cycles, or wavelengths, between the GNSS device and a satellite transmitting the GNSS signal. Solving for the number of cycles involves determining a fractional number of cycles plus an integer number of cycles. The integer number of cycles is known as the integer ambiguity. When problems arise in the GNSS signal, such as multipath or other issues, cycle slips can occur that may cause the GNSS receiver to incorrectly estimate the integer ambiguity. Detecting and correcting for such cycle slips is a key aspect of maintaining an accurate GNSS-based position.

Embodiments address these and other issues by providing techniques to detect and correct for cycle slips in GNSS positioning. Generally put, these techniques involve using measurements from a series of continuous GNSS epochs in which certain preliminary conditions are met. These preliminary conditions include (i) the series of epochs has no discontinuities, and (ii) there is no change in reference satellite in the series (they all use the same GNSS satellite for measurements). If these preliminary conditions are met, embodiments comprise using a first set of rounded values for the integer ambiguity values corresponding to the float ambiguity values of the epochs in the series, then analyzing the first set of rounded values to determine final integer ambiguity values for the set of epochs. Embodiments can include determining offset between the first set of rounded values and a second set of rounded values, and conducting further analysis of the offset to determine which set of rounded values to use as the final integer ambiguity values. Some embodiments comprise determining a most common rounded value for the float ambiguity values and conducting an analysis of whether one or more other rounded values are used. Details regarding these various techniques are provided in the embodiments described herein.

Particular aspects of the subject matter described in this disclosure can be implemented to realize one or more of the following potential advantages. In some examples, by using multiple epochs samples to determine a GNSS positioning result, the described techniques can correct any cycles slips that may occur during the epochs. Moreover, techniques are not dependent on multi-band and can have high detection sensitivity. Furthermore, techniques may utilize one or more of multiple algorithms with differing processing requirements and cycle slip correction efficacy, which can enable GNSS devices to use an algorithm that balances processing requirements with efficacy, given various factors, such as positioning accuracy requirements, GNSS device capabilities, and so forth. These and other advantages will be apparent to a person of ordinary skill in the art in view of the embodiments described below.

Various embodiments are provided in detail hereafter, following a review of applicable technology.

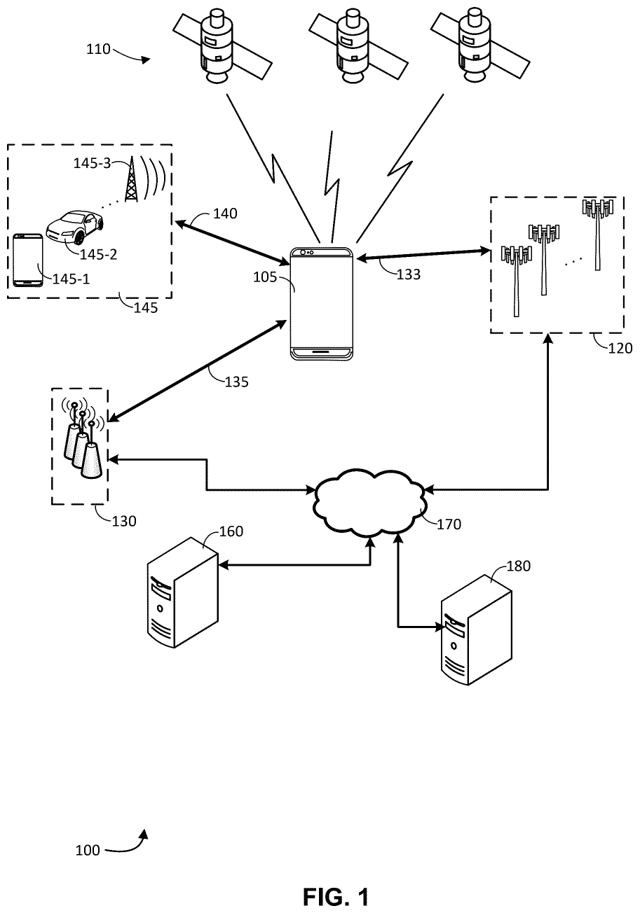

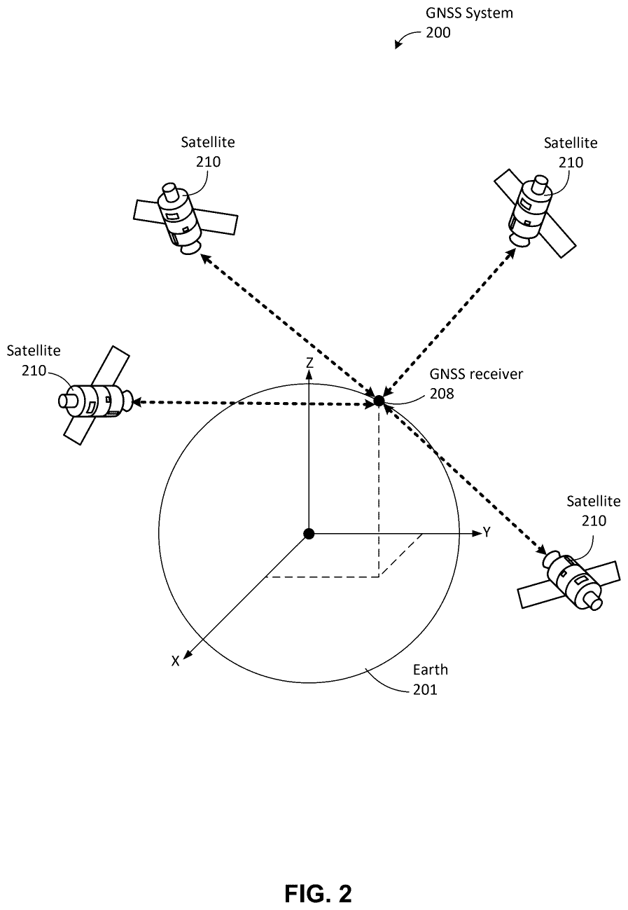

FIG. 1 is a simplified illustration of a positioning system 100 in which a mobile device 105, location server 160, and/or other components of the positioning system 100 can use the techniques provided herein for determining cycle slip, according to an embodiment. The techniques described herein may be implemented by one or more components of the positioning system 100. The positioning system 100 can include a mobile device 105; one or more satellites 110 (also referred to as space vehicles (SVs)) for a GNSS such as the global positioning system (GPS), GLONASS (GLO), Galileo (GAL), or BeiDou Navigation Satellite System (BDS); base stations 120; access points (APs) 130; location server 160; network 170; and external client 180. Generally put, the positioning system 100 can estimate the location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additional details regarding GNSS-based positioning are discussed in more detail with regard to FIG. 2.

In this example, FIG. 1 illustrates the mobile device 105 as a smartphone device. However, mobile devices capable of performing the techniques described herein may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of devices as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with the known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, and/or static communication/positioning device 145-3. When or more other mobile devices 145 are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. The static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of another mobile device 145 at some known previous time). As noted elsewhere herein, a location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as a friend or relative finder, or child or pet location). Additionally or alternatively, the external client 180 may obtain and provide the location of mobile device 105 to an emergency services provider, government agency, etc.

As noted, the mobile device 105 of FIG. 1 may be capable of GNSS positioning. Details regarding the GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 208 on earth 201 (also known as “positioning” of the GNSS receiver). Put generally, the GNSS system 200 enables an accurate GNSS position fix of the GNSS receiver 208, which receives RF signals from GNSS satellites 210 (which may correspond with satellites 110 of FIG. 1) from one or more GNSS constellations. The types of GNSS receiver 208 used may vary, depending on the application. In some embodiments, for instance, the GNSS receiver 208 may comprise a standalone device or component incorporated into another device (e.g., mobile device 105 of FIG. 1). This can include, for example, consumer electronics or devices, such as a mobile phone, tablet, laptop, wearable device, vehicle (or in-vehicle device), or the like. In some embodiments, the GNSS receiver 208 may be integrated into industrial or commercial equipment, such as survey equipment, Internet of Things (IoT) devices, etc.

It will be understood that the diagram provided in FIG. 2 is greatly simplified. In practice, there may be dozens of satellites 210 in a given GNSS constellation, and many different types of GNSS systems with corresponding constellations. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, determining the position of a GNSS receiver 208 in three dimensions may rely on determining the distance between the GNSS receiver 208 and four or more satellites 210. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 210 and the GNSS receiver 208 may be determined using precise measurements made by the GNSS receiver 208 of a difference in time from when an RF signal is transmitted from the respective satellite 210 to when it is received at the GNSS receiver 208. To help ensure accuracy, not only does the GNSS receiver 208 need to accurately determine when the respective signal from each satellite 210 is received, but many additional factors need to be considered and accounted for. These factors include, for example, clock differences at the GNSS receiver 208 and satellite 210 (e.g., clock bias), a precise location of each satellite 210 at the time of transmission (e.g., as determined by the broadcast ephemeris), the impact of atmospheric distortion (e.g., ionospheric and tropospheric delays), and the like.

To perform a traditional GNSS position fix, the GNSS receiver 208 can use code-based positioning to determine its distance to each satellite 210 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 210, the GNSS receiver 208 can then determine a position fix for its location. This position fix may be determined, for example, by a Standalone Positioning Engine (SPE) executed by one or more processors of the GNSS receiver 208. However, code-based positioning is relatively inaccurate and, without error correction, and is subject to many of the previously described errors. Even so, code-based GNSS positioning can provide a positioning accuracy for the GNSS receiver 208 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 210 observed by the GNSS receiver 208 can be mitigated or canceled based on similar carrier-based ranging of the satellites 210 using a highly accurate GNSS receiver at the base station at a known location. These measurements and the base station's location can be provided to the GNSS receiver 208 for error correction. This position fix may be determined, for example, by a Precise Positioning Engine (PPE) executed by one or more processors of the GNSS receiver 208. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 210 may be members of a single satellite constellation, i.e., a group of satellites that are part of a GNSS system, e.g., controlled by a common entity such as a government, and orbiting in complementary orbits to facilitate determining positions of entities around the world. One or more of the satellites 210 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites; the X-band, used by the military and for RADAR applications; and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As previously noted, precise positioning (e.g., RTK or PPP positioning) may utilize error correction provided by an error correction service. Error correction is typically provided using SSR or OSR. As previously noted, OSR utilizes a format in which a “lump sum” of error components for carrier phase and pseudorange measurements are provided, typically from a local physical reference station positioning reference signal (PRS). SSR, on the other hand, provides correction of individual error components, such as orbit, clock, SV PCO, and DCB. When SSR transmits enough information, the accuracy of resulting positioning estimates based on SSR can be comparable to the accuracy achieved using OSR. Furthermore, free SSR (with regional or global coverage) is often available for at least some GNSS frequency bands from services such as Quasi-Zenith Satellite System (QZSS) Centimeter Level Augmentation Service (CLAS), QZSS Multi-GNSS Advanced Orbit and Clock Augmentation-Precise Point Positioning (MADOCA-PPP), Galileo (GAL) High Accuracy Service (HAS), and BDS PPP-B2b.

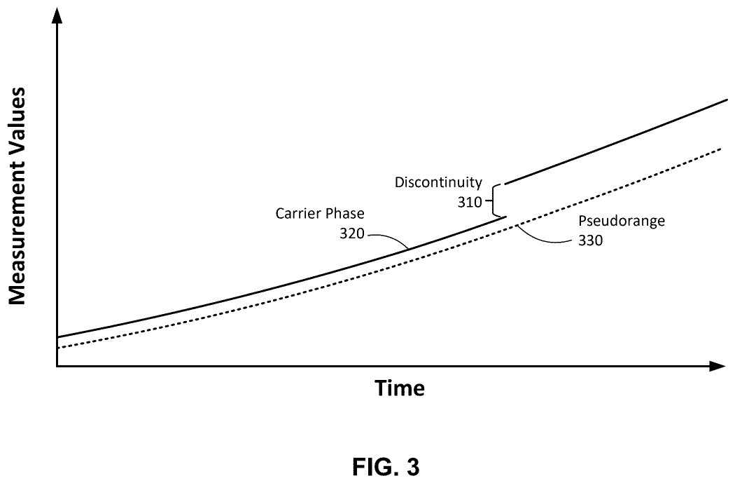

FIG. 3 is a graph provided to help illustrate the problem of cycle slip. A cycle slip is a discontinuity in a GNSS receiver's carrier phase (CP) lock on a satellite signal, which often occurs during a receiver loss-of-lock event. This can occur due to factors such as signal obstruction, multipath, ionospheric disturbances, hardware and/or software issues, or the like. As illustrated in the simplified example shown in FIG. 3, a cycle slip can cause a discontinuity 310 in carrier phase measurement values 320 (e.g., number of cycles). However, as also shown, a cycle slip may not impact pseudorange values 330 (e.g., in meters or another unit of distance).

A cycle slips impact on carrier phase and impact overall positioning performance. As previously noted, carrier phase is used in precise GNSS positioning (e.g., RTK, PPP, or PPP-RTK). If cycle slips are not detected and accounted for, the positioning accuracy for the GNSS receiver can suffer. A cycle slip causes the critical component for successful carrier phase positioning, a resolved integer cycle ambiguity, N (also referred to herein as “integer ambiguity”), to become unknown again. In other words, “lock” is lost, which can degrade the accuracy of high-performance GNSS positioning.

Embodiments herein provide new GNSS cycle slip detection methods that may use multiple epoch samples to detect and correct cycle slips. This can be particularly useful in GNSS devices with slow positioning cadence (e.g., Internet of things (IoT), automotive, and/or smart phone applications, etc.) or cloud-based solutions, in which the GNSS measurement sampling rate may be higher than the positioning result output rate. For example, in some scenarios, measurements may be taken at 1 Hz or 10 Hz, whereas positioning outputs might be once every five or 10 seconds.

Existing techniques for cycle slip detection may be insufficient in various circumstances. For example, measurement-engine-based cycle slip detection methods may be straightforward to implement without any positioning engine dependency, however, they may still cause issues in performance. Solutions using code-phase combinations may be unable to that are buried under amplified signal noise, and may also cause issues in performance. Solutions using a geometry-free combination may have high detection sensitivity, but depend on multi-bends data. Embodiments herein, which may be implemented in use cases where multiple epoch samples are available for a single positioning result can have high detection sensibility, without a dependency on multi-band, and with less impact on performance.

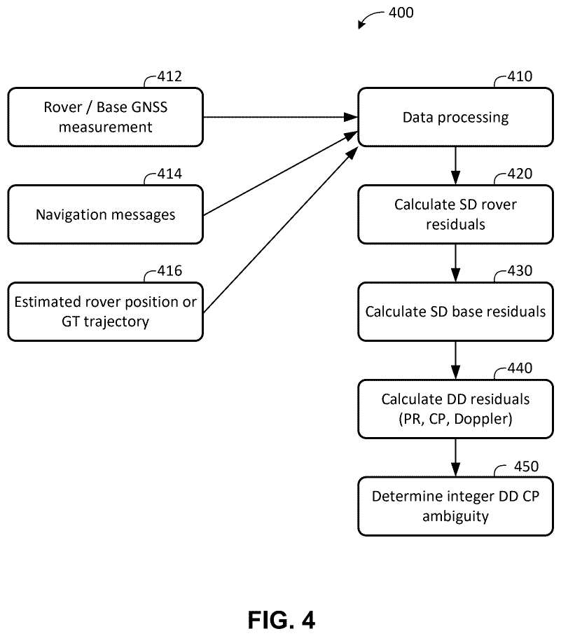

Cycle slip detection may be implemented for various reasons within GNSS positioning. FIG. 4, described below, is an illustration of one such process in which cycle slip detection can be used in the determination of a double difference (DD) integer CP ambiguity.

FIG. 4 is a flow diagram of a process 400 by which integer DD CP ambiguity may be determined, according to some embodiments. As with other figures provided herein, FIG. 4 is provided as a non-limiting example. A person of ordinary skill in the art will appreciate how different modifications may be made (e.g., changing the order of some functions, performing certain functions in parallel, etc.) while ultimately achieving a similar end result that can be used in alternative embodiments.

The process 400 may begin at block 410 with the data processing operation that may use various data inputs. As illustrated, these inputs include rover and base GNSS measurements (or equivalent for non-RTK solutions) shown with block 412, navigation messages (e.g., satellite trajectory) shown with block 414, and an estimated rover position or ground truth (GT) trajectory shown with block 416. The estimated rover position or GT trajectory may be based on availability or use cases: estimated rover position may be used in real-time GNSS receiver products, and GT trajectory can be used in postprocessing software applications, for example. According to some embodiments, the data processing at block 410 may include a rough initial processing of the inputs to help ensure their validity. As such, this may include an initial “sanity check” to ensure a correct sampling rate, ensure no cycle slip has occurred, or otherwise prevent the process from proceeding if inputs are determined to include bad data.

Single-difference (SD) residuals may then be calculated for rover and base (or equivalent for non-RTK solutions), as indicated with blocks 420 and 430, respectively. According to some embodiments, SD residuals can be calculated using a reference satellite from which measurements from other satellites may be subtracted, which can result in the cancellation/correction of receiver-based components of CP measurements (e.g., receiver clock). As a person of ordinary skill in the art will appreciate, a reference satellite may be chosen based on various factors. For example, according to some embodiments, a satellite with the highest elevation (among detected satellites) may be chosen because the RF signal from that satellite is least likely to experience multipath. As indicated at block 440, the double difference (DD) may then be used to calculate residuals for GNSS measurements (e.g., PR, CP, and Doppler) made by the GNSS device (e.g., rover). (The residuals calculated in block 440 are initial DD residuals that may be improved utilizing the techniques described herein.)

The integer DD of the CP ambiguity may then be determined, as indicated at block 450, using the residuals calculated at block 440. This can be done, for example, using a search method (e.g., Least Squares Ambiguity Decorrelation Adjustment (LAMBDA) for using a simple round-up method. When using the round-up method, some embodiments may employ cycle slip detection to help ensure accurate ambiguity determination.

According to some embodiments, the determination of a DD residual (e.g., determined at block 440 of FIG. 4) may be as follows:

$${DD}_{CP} residual = DD ( CP ) - DD ( truth range ) = X . Y , \qquad ( Eqn . 1 )$$

where DD(CP) is the determined DD CP, DD(truth range) is the DD CP with applied error correction/cancellation, X is the integer component of ambiguity cycles (solved for using a search method or roundup method, as noted above), and Y is a non-integer part of the CP residual. In most cases (without cycle slip), the absolute value of Y is less than a half cycle. That is, −0.5 cycle<Y<0.5 cycle. (In cases where Y falls outside of this range, it may be treated as an outlier and either repaired or removed from use in the determination of reliable residuals.)

With respect to Eqn. 1 above, a couple of items may be noted. First, DD_{CP}residual=DD(CP)−DD(truth range) is an approximation of the true residual of GNSS DD CP measurement, and may include errors such as DD SV clock, SV orbit, troposphere, ionosphere, noise, multipath, etc. Second, the DD(truth range) term may include errors such as based position offset, rover position offset, phase center variation (PCV) at base, PCV at rover, etc. These can therefore impact the value of Y.

As noted, according to some embodiments, integer ambiguity (X) may be found using a round-up method, and the DD CP residual is typically less than half cycle (e.g., −0.5 cycle<Y<0.5 cycle) when a measurement is clean. Using this information, cycle slip may then be determined from an analysis of X.Y values across multiple epochs. Table 1 illustrates an example.

TABLE 1
First Example of Cycle Slip Values

| Epoch | X · Y Value |
|---|---|
| 0 | 7.2 |
| 1 | 7.1 |
| 2 | 7.9 |
| 3 | 7.1 |

In the example of Table 1, epochs 0 and 1 have X.Y values of 7.2 and 7.1, respectively. At epoch 3, however, the X.Y value jumps to 7.9 before returning to 7.1 at epoch 3. (Using a roundup algorithm, the value of X may be modified from 7 to 8, and the value of Y may be modified from 0.9 to −0.1.) In this example, the value 7.9 is an outlier and may be determined to be a cycle slip.

Table 2 illustrates another example.

TABLE 2
Second Example of Cycle Slip Values

| Epoch | X · Y Value |
|---|---|
| 0 | 7.2 |
| 1 | 7.1 |
| 2 | 7.9 |
| 3 | 7.8 |
| 4 | 7.9 |

In the example of Table 2, X.Y values for epochs 0-2 are similar to the example of Table 1. In the Table 2, however, values at epochs 3 and 4 remain are 7.8 and 7.9, respectively. Thus, in contrast with the example of Table 1, values subsequent to the jump at epochs 2 remain high. This means that the cycle slip that occurs at epoch 2 might be more difficult to detect using traditional cycle slip detection algorithms because the value 7.9 is not necessarily an outlier in view of subsequent values.

Embodiments herein may employ one or more of various cycle slip detection algorithms to detect and/or correct cycle slips in a series of successive GNSS epochs. Various algorithms are described below.

### Algorithm 0

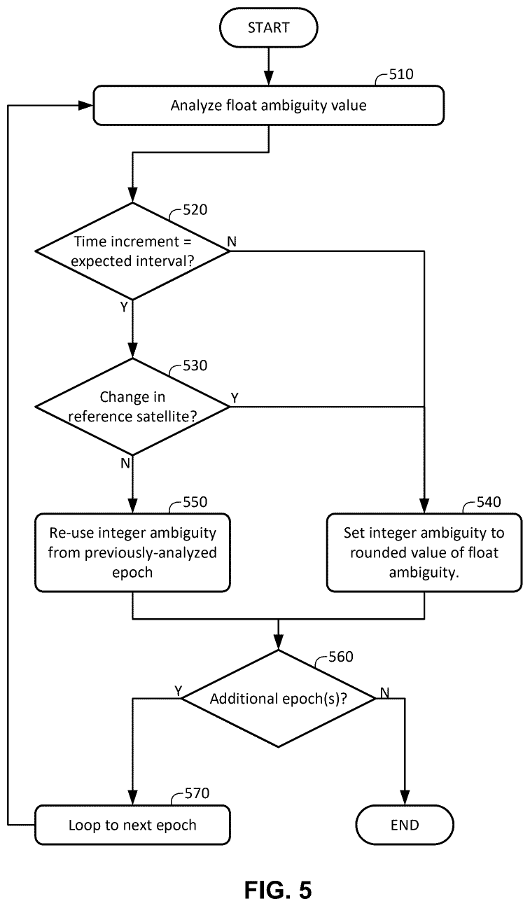

FIG. 5 is a flow chart of an initial algorithm, referred to herein as “Algorithm 0,” which is provided herein as a baseline algorithm for detecting cycle slips by analyzing low ambiguity values across multiple epochs, according to an embodiment. In Algorithm 0, the process can loop through float ambiguity values (e.g., X.Y values) for a series of successive epochs, using either a forward determination and/or backward determination. In a forward determination, the algorithm loops through input float ambiguities from the smallest (e.g., earliest) time to the largest (e.g., most recent) time. A backward determination loops through input float ambiguity from the largest time to the smallest time. Here, the series of successive epochs may comprise some or all epochs since a previous GNSS positioning determination was made. In the case where some epochs are used, this may be a set number (e.g., five, 10, 25, 50, 100, etc.) of the most recent epochs, which may be based on implantation.

Algorithm 0 may begin with the functionality of block 510 in which a float ambiguity value is analyzed. The functionality at block 520 and 530 help ensure that certain preliminary conditions regarding interval and satellite continuity are met. If the time increment for the value does not equal the expected interval (as shown by the determination at block 520) (e.g., 1 second in 1 Hz data) or if there is a change in the reference satellite (as shown by the determination at block 530) from the previously analyzed float ambiguity value, then the process can proceed to block 540, in which the integer ambiguity (e.g., X) is set to the rounded value of the float ambiguity. (In the case where an X.Y value is 7.8, for example, the integer ambiguity would be routed to 8.) The analysis of the time increment at block 520 can ensure that the integer ambiguity is set to the rounded value of the float ambiguity in cases where there may be a lapse in the determination of X.Y values for one or more epochs. Otherwise, if the time increment is able to the expected interval and there is no change in the reference satellite, then the integer ambiguity for the previously-analyzed epoch will be reused for the current epoch, as indicated at block 550. The process can then loop through the remaining epochs, as indicated at block 560 and block 570. In the case of forward determination, the “next” epoch at block 570 would be the epoch following the present epoch in time. In the case of backward determination, the “next” epoch at block 570 would be the epoch preceding the present epoch in time.

In the example of Table 2, for example, assuming time between epochs is equal (e.g., one second) and there is no change in the reference satellite, then a forward determination would result in the value 7 being used for all epochs. This is because 7 is used as the initial value for X at epoch 0, so 7 is reused across all epochs because there is no jump in time or change of reference satellite. (It can be noted that this would fail to detect a cycle slip at epoch 2.)

In the example of Table 2, (again, assuming time between epochs is equal and there is no change in the reference satellite), a backward determination would result in the value 8 being used for all epochs. This is because 8 is used as the initial value for X at epoch 4, after round-up, so 8 is reused across all epochs because there is no jump in time or change of reference satellite.

It can be noted that forward and backward determinations using Algorithm 0 are often used independently. The forward determination may be used as a default, for example. And the backward determination may be used in cases where forward determination is found to be insufficient in a given use case. Even so, as shown in the example above, both forward and backward determinations may not be robust enough to identify the cycle slip in the example of Table 2 provided above.

### Algorithm 1

“Algorithm 1” is an algorithm for detecting cycle slips that improves on Algorithm 0 by filtering results based on the difference between forward and backward determinations of Algorithm 0. To do so, Algorithm 1 may first determine an offset between forward and backward determinations in each epoch of a set of successive epochs.

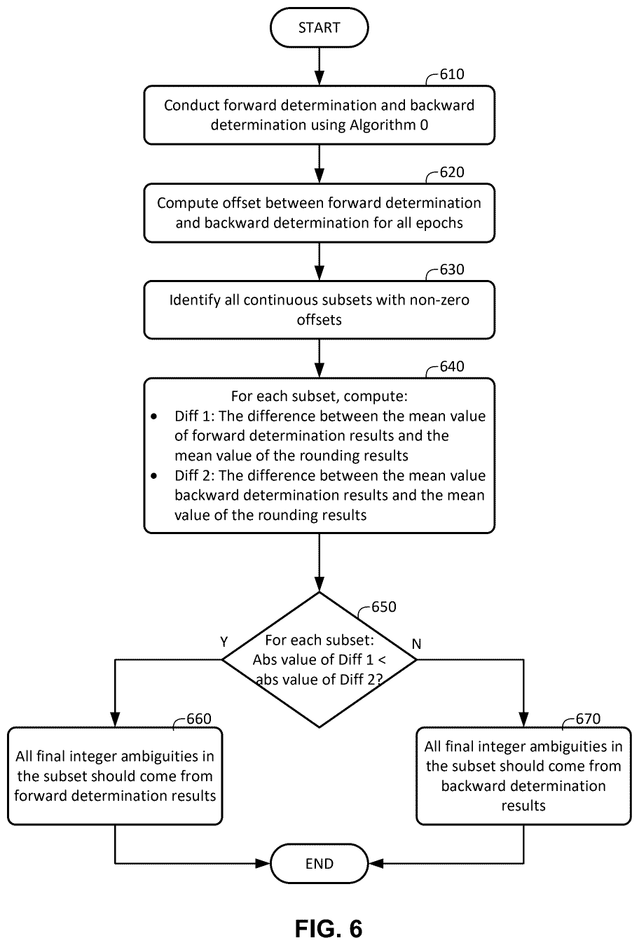

FIG. 6 is a flowchart illustrating an embodiment of Algorithm 1. As illustrated, Algorithm 1 may begin with the functionality of block 610, in which forward and backward determinations are determined using Algorithm 0 (e.g., the process shown in FIG. 5, for both forward and backward determinations). Then, an offset, or difference, between rounded integer ambiguity values from forward and backward determinations can be computed for all epochs in the set of epochs (shown by block 620), and each subset of continuous epochs having a non-zero offset is identified (block 630). Here, a subset may comprise a series successive epochs, within the set epochs, having non-zero offset values. Thus, a set of epochs may comprise multiple subsets that are separated by one or more epochs having offset values of zero. In Algorithm 1, a single subset may have more than one non-zero offset value.

Once subsets are identified, the functionality at block 640 may then be performed in which, for each identified subset, two values are computed: Diff 1 and Diff 2. Diff 1 is the difference between the mean value of forward determination results and the mean value of the rounding results, and Diff 2 is the difference between the mean value of backward determination results and the mean value of the rounding results. Each identified subset may then be analyzed, as shown by block 650, to determine whether the absolute value of Diff 1 is less than the absolute value of Diff 2. If so, all integer ambiguity values in the subset come from the forward determination results, as shown by block 660. Otherwise, all integer ambiguity values in the subscome from the backward determination results, as shown by block 660.

Table 3 illustrates an example of Algorithm 1 applied to the X.Y values of Table 2, in which offsets for each epoch are determined.

TABLE 3
Offset Determination for Algorithm 1

| | X · Y | FD float | BD float | |
|---|---|---|---|---|
| Epoch | Value | ambiguity | ambiguity | Offset |
| 0 | 7.2 | 7 | 8 | 1 |
| 1 | 7.1 | 7 | 8 | 1 |
| 2 | 7.9 | 7 | 8 | 1 |
| 3 | 7.8 | 7 | 8 | 1 |
| 4 | 7.9 | 7 | 8 | 1 |

In Table 3, the first two columns echo those of Table 2 above. The third column shows forward determination (FD) values of float ambiguity (X) after roundup is applied, in accordance with Algorithm 0 above. (As noted above, these values remain at 7 because there is no disruption in epochs or change of reference satellite.) The fourth column shows backward determination (BD) values of float ambiguity (X) after roundup is applied, in accordance with Algorithm 0 above. (As noted above, these values are all 8, as described above.) The final column shows the offset (difference) between the FD float ambiguity of column 3 and BD float ambiguity of column 4. As shown, in this example, all epochs have a non-zero offset, and therefore comprise a single subset.

As shown in FIG. 6, once epochs with non-zero offsets are identified, Algorithm 1 determines values for Diff 1 and Diff 2 for each epoch with a non-zero value. These values are determined from values of forward and backward determinations, as well as the mean value of rounding results.

Table 4 continues the example of Tables 2 and 3, showing roundup (rounding results), Diff 1, and Diff 2 values for all epochs in the example subset.

TABLE 4
Diff 1 and Diff 2 Calculations for Algorithm 1

| Epoch | X · Y Value | Roundup | Diff 1 | Diff 2 |
|---|---|---|---|---|
| 0 | 7.2 | 7 | −0.6 | 0.4 |
| 1 | 7.1 | 7 | −0.6 | 0.4 |
| 2 | 7.9 | 8 | −0.6 | 0.4 |
| 3 | 7.8 | 8 | −0.6 | 0.4 |
| 4 | 7.9 | 8 | −0.6 | 0.4 |

Here, the mean value of rounding results (column 3 of Table 4) is 7.6. Diff 1, then, is calculated from the difference between the value of forward determination results (7) and the mean value of the rounding results (7.6). Diff 2 is calculated from the difference between the mean value of backward determination results (8) and the mean value of the rounding results (7.6). Because the absolute value of Diff 1 is not smaller than the absolute value of Diff 2, the final integer ambiguities used for GNSS position determination, for all epochs, use the backward determination results (see blocks 650 and 670 of FIG. 6). In this example, the final integer ambiguities for all epochs in the subset would be 8 (see column 4 of Table 3).

### Algorithm 2

Algorithm 2 is similar to Algorithm 1 but with more precise groupings of epochs based on offset values. That is, rather than creating subsets of epochs having any non-zero values, Algorithm 2 may create subsets of epochs that have the same non-zero value.

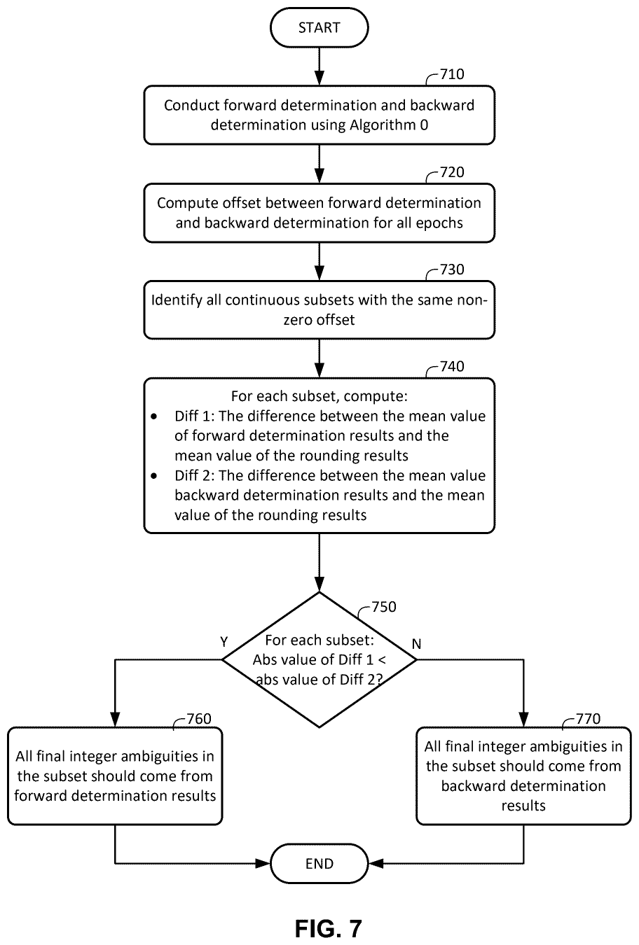

FIG. 7 is a flowchart illustrating an embodiment of Algorithm 2. As illustrated, the functionality of blocks 710-770 of Algorithm 2 may echo the functionality of corresponding blocks 610-670 of Algorithm 1, described above. In Algorithm 2, however, block 730 comprises identifying subsets of continuous epochs with the same non-zero offset (rather than continuous epochs having any non-zero offset, as in Algorithm 1 above). Algorithm 2 then proceeds to determine and analyze Diff 1 and Diff 2 values for successive epochs having the same non-zero offset.

### Algorithm 3

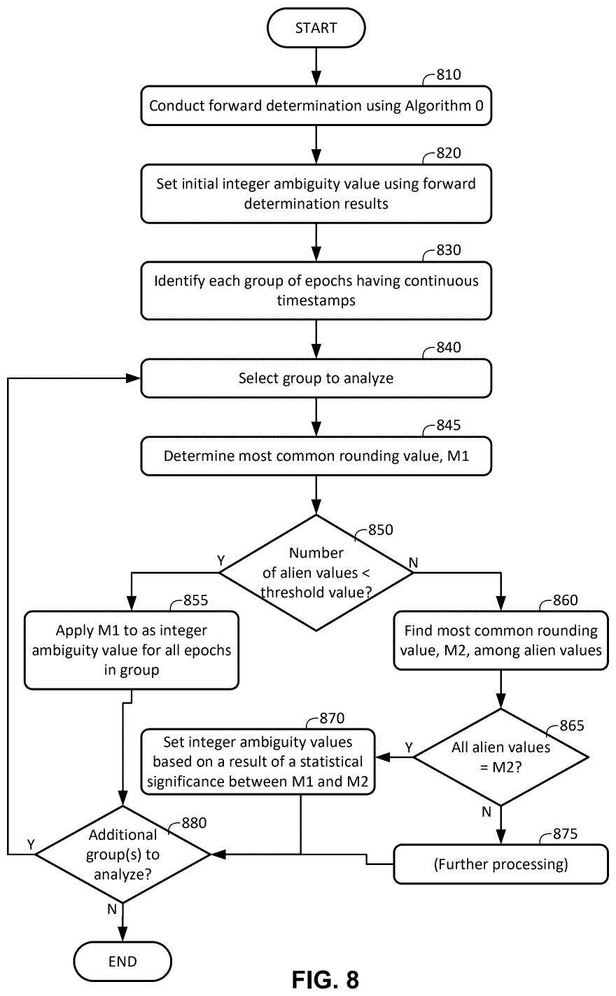

FIG. 8 is a flow diagram of an embodiment of Algorithm 3. It may begin by conducting a forward determination using Algorithm 0, as indicated by block 810, then setting the initial integer ambiguities value using forward determination results, as indicated by block 820. Among these results, one or more groups of epochs having continuous timestamps can be identified, as indicated at block 830. For example, if X.Y values are determined for epochs 0-4 and 6-9, but no values are determined for epoch 5, then the disruption at epoch 5 creates two groups: one group comprising values for epochs 0-4 and another group comprising values for epochs 6-9.

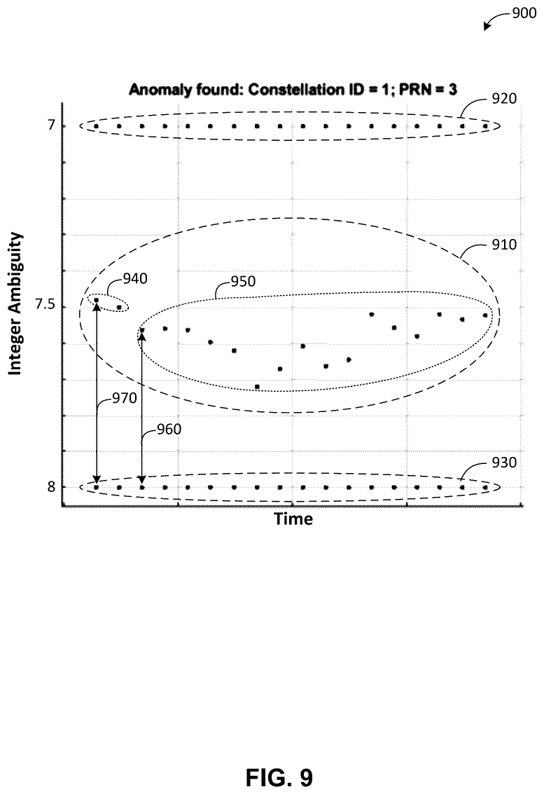

The functionality of blocks 840-880 may be performed for each group identified in block 830. This comprises selecting a group to analyze at block 840, then determining the most common rounding value, M1, among float ambiguities of the epochs in the group. (The order of group selection may be implementation specific, such as largest group to smallest group, the first group to the last group (in time), etc.) Functionality at block 850 comprises determining how many alien values exist among the group. In this context “alien” values are values that are not the most common rounding value, M1. If there are fewer than a threshold number of alien values, then the process can proceed to the functionality of block 855, where M1 is applied as the integer ambiguities value for all epochs in the group. According to some embodiments, if there are only zero or one alien values, then the functionality at block 855 can be performed. Other embodiments may have a lower or higher threshold number, depending on desired functionality. Other embodiments may comprise a dynamic threshold number, based on the number of values in the group (e.g., based on a percentage, for example). Otherwise, if the number of alien values is not less than a threshold value, then the functionality at block 860 may be performed, in which the most common rounding value among alien values, M2, is determined. As indicated at block 865, if all alien values are M2, then the process can proceed to block 870, at which a statistical significance between M1 and M2 is performed and used to set integer ambiguity values for the epochs in the group. (An example statistical significance algorithm is provided in more detail below, with respect to FIG. 9.) Otherwise, if one or more alien values are not M2, then further processing may be performed, as indicated at block 875. Such instances are extremely rare (the inventors have not come across any such instances), but further processing may be implemented to treat such rare instances. A process similar to the statistical significance determination at block 870 may be performed, for example, which compensates for one or more additional alien values (e.g., M3, M4, etc.).

FIG. 9 is a graph 900 of experimental results of using Algorithm 3 on GNSS data, according to some embodiments. The graph 900 plots integer ambiguity values over time (across many epochs). (To avoid clutter, integer ambiguity values are shown as values ranging from 7 to 8. The actual integer ambiguity values in the experimental data range from −1.8693647×10⁷ to −1.8693648×10⁷.) As and be seen, the graph 900 includes three groups of plots: a first group 910 includes raw integer ambiguity values (prior to rounding), a second group 920 shows values after Algorithm 0 (using forward determination) has been applied, and the third group 930 shows values after Algorithm 3 has been applied). To be clear, only one group would be used for position determination of a GNSS device. However, all three groups are shown here to provide a comparison between the results of using Algorithm 0 with results of using Algorithm 3.

The reason why Algorithm 0 rounds values of the first group 910 to 7 is clear in view of a forward determination process applied to the values in the first group 910. Because the initial value is below 7.5, all values in the group are then rounded to 7.

The reason why Algorithm 3 rounds values up to 8 becomes clear under analysis of the functionality of blocks 840-880 of FIG. 8. After values are initially rounded to 7 using algorithm zero (in accordance with blocks 810-830), the values of the epochs illustrated in graph 900 are reevaluated under blocks 840-880 to determine whether this value should change. Specifically, all values illustrated in graph 900 may comprise a single group because all values are continuous (there are no discontinuities in the epochs plotted in graph 900). Subgroups 940 and 950 may then be identified as groups having different rounding values if rounded individually, where subgroup 940 is rounded to 7, and subgroup 950 is rounded to 8. According to the functionality at block 845 of FIG. 8, Algorithm 3 then determines the most common rounding value, M1. In this case, because subgroup 950 includes more values than subgroup 940, M1=8. At block 850 of FIG. 8, it is determined whether the number of alien values (in this case, subgroup 940) is less than a threshold value. In this example, the threshold value is 2 (meaning that M1 will only be assigned to the entire group 910 if there are less than 2 alien values). Thus, Algorithm 3 then proceeds to the functionality at block 860, in which the most common rounding value among alien values, M2, is determined. In this case, both values in subgroup 940 are rounded to 7, so M2=7. Because all alien values equal M2 (see block 865 of FIG. 8) a statistical significance is determined between M1 and M2.

Generally put, the statistical significance determination performed in Algorithm 3 (at block 870) can determine whether alien ambiguities are statistically significant in view of M1 and M2 values. An example of statistical significance determination may comprise:
Computing the absolute distance (or numerical difference) between each float ambiguity value rounded to M1 and M1. In the example of FIG. 9, this would involve computing the absolute distance between each value in the subgroup 950 with the value of M1 (8). (Line 960 illustrates an example absolute distance computed between one float ambiguity and M1 for one float ambiguity value.)
Computing the absolute distance between the float ambiguity for each alien value and M1. In the example of FIG. 9, this would involve computing the absolute distance between each point in the subgroup 940 with the value of M1 (8). (Line 970 illustrates an example absolute distance computed between one float ambiguity and M1 for one float ambiguity value.)
Based on these distances, identify each alien value that passes or fails a statistical significance check. According to some embodiments, the statistical significance check may implement a threshold statistical significance ratio of 0.5, although alternative embodiments may “tune” this ratio to a different value, depending on desired functionality. Generally put, in the example of FIG. 9, alien values in subgroup 940 fail the statistical significance check because the float ambiguity values are similar to the float ambiguity values in subgroup 950. (If the subgroup 940 were closer to 7, they may be found statistically significant and therefore pass the statistical significance test.)
Set M1 as the integer ambiguity value for float ambiguity values that were initially rounded to M1. In the example of FIG. 9, this would involve assigning the integer ambiguity value M1 (8) to the epochs having float ambiguity values in the subgroup 950.
Set M1 as the integer ambiguity value for alien float ambiguity values that failed the statistical significance check. In the example of FIG. 9, this would involve assigning the integer ambiguity value M1 to the epochs having the float ambiguity values in the subgroup 940. Although initially rounded to M2 (7), these values failed to the statistical significance check and are therefore assigned the integer ambiguity value M1 (8).
Set M2 as the integer ambiguity value for alien float ambiguity values that passed the statistical significance check. In the example of FIG. 9, no alien float ambiguity values passed in the statistical significance check, and therefore no alien float ambiguity values would be assigned an integer ambiguity value of M2 (7).

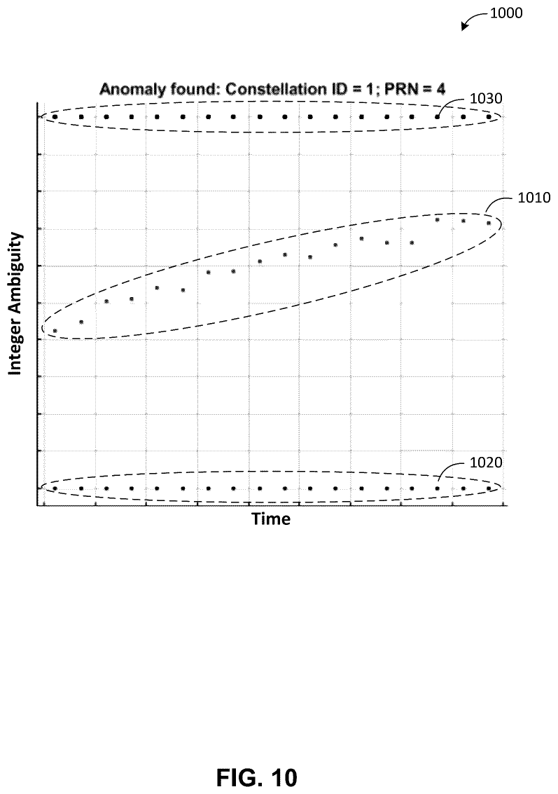

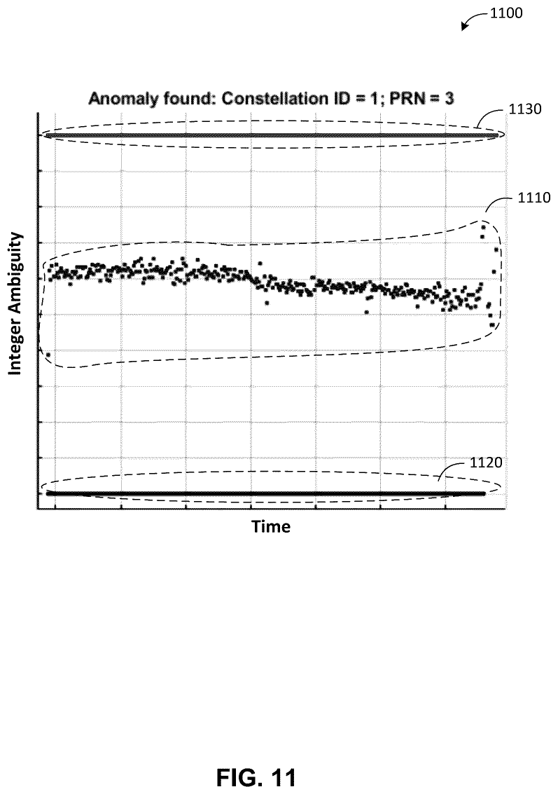

FIGS. 10 and 11 described below, are figures similar to FIG. 9, illustrating the outputs of Algorithms 1 and 2, respectively, with respect to Algorithm 0.

FIG. 10 is a graph 1000 of experimental results of using Algorithm 1 on GNSS data, according to some embodiments. As and be seen, the graph 1000 includes three groups of plots: a first group 1010 includes raw (float) integer ambiguity values (prior to rounding), a second group 1020 shows values after Algorithm 0 (using forward determination) has been applied, and the third group 1030 shows values after Algorithm 1 has been applied). Again, all three groups are shown here to provide a comparison between the results of using Algorithm 0 and the results of using Algorithm 1.

FIG. 11 is a graph 1100 of experimental results of using Algorithm 2 on GNSS data, according to some embodiments. As and be seen, the graph 1100 includes three groups of plots: a first group 1110 includes raw (float) integer ambiguity values (prior to rounding), a second group 1120 shows values after Algorithm 0 (using forward determination) has been applied, and the third group 1130 shows values after Algorithm 1 has been applied). Again, all three groups are shown here to provide a comparison between the results of using Algorithm 0 and the results of using Algorithm 1. (It can be noted that this graph uses much more data, resulting in many more epochs per group.)

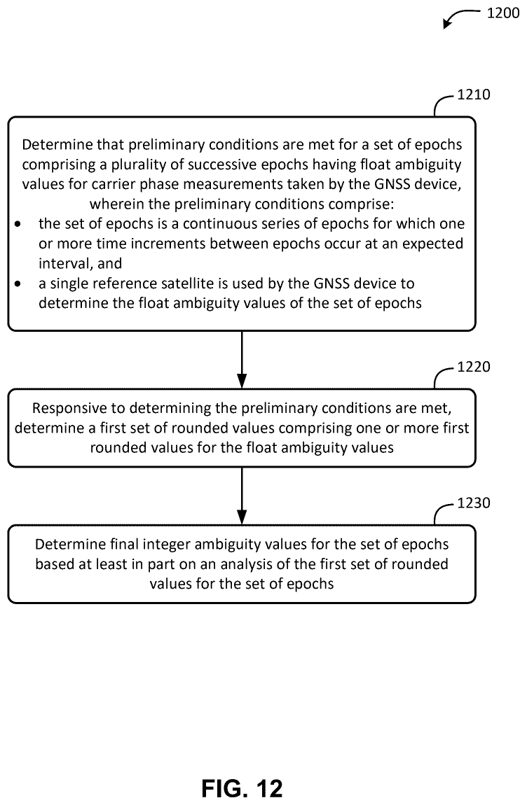

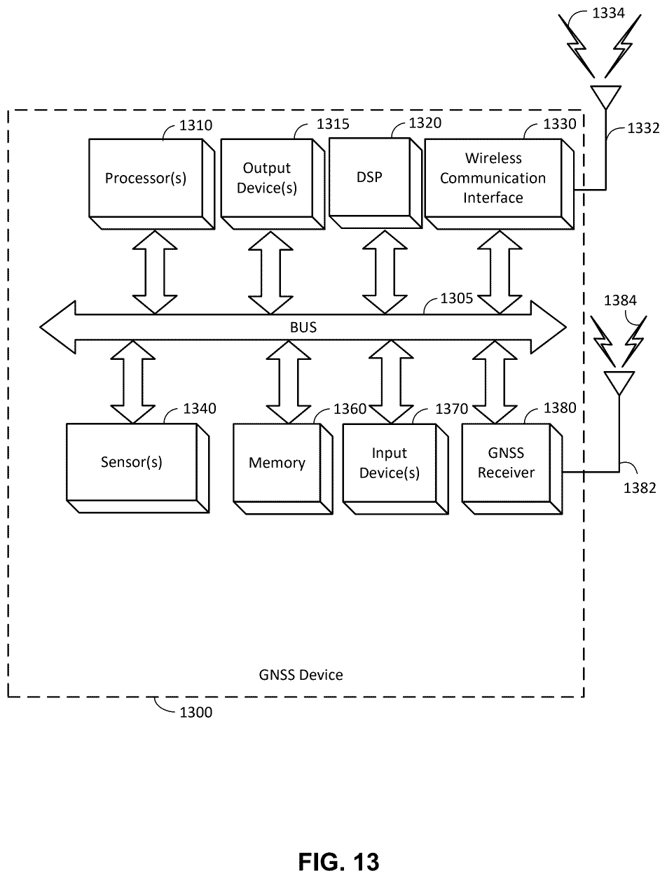

FIG. 12 is a flow diagram of a method 1200 of global navigation satellite system (GNSS) positioning of a GNSS device, according to an embodiment. Means and/or structure for performing the functionality illustrated in one or more of the blocks shown in FIG. 12 may be performed by hardware and/or software components of a GNSS device, for example. Example components of a GNSS device are illustrated in FIG. 13, which is described in more detail below.

At block 1210, the functionality comprises determining that preliminary conditions are met for a set of epochs comprising a plurality of successive epochs having float ambiguity values for carrier phase measurements taken by the GNSS device, wherein the preliminary conditions comprise: the set of epochs is a continuous series of epochs for which one or more time increments between epochs occur at an expected interval, and a single reference satellite is used by the GNSS device to determine the float ambiguity values of the set of epochs. The determination of whether these preliminary conditions are met may correspond with the functionality of blocks 520 and blocks 530 in FIG. 5, discussed above, for example. As noted in the embodiments above, the set of epochs may correspond with epochs occurring since a previous positioning determination of the GNSS device, or a subset thereof (which may be determined based which epochs are the most recent, for example).

Means and/or structure for performing functionality at block 1210 may comprise a bus 1305, one or more processors 1310, a digital signal processor 1320, one or more memories 1360, a GNSS receiver 1380, and/or other components of a GNSS device 1300, as illustrated in FIG. 13.

The functionality at block 1220 comprises, responsive to determining the preliminary conditions are met, determining a first set of rounded values comprising one or more first rounded values for the float ambiguity values. Generally put, the first set of rounded values may comprise and initial set of values determined from an initial analysis, such as a forward or backward determination using Algorithm 0. As described in the embodiments herein, these initial values may be used in subsequent analysis in Algorithms 1, 2, or 3, for example.

Means and/or structure for performing functionality at block 1220 may comprise a bus 1305, one or more processors 1310, a digital signal processor 1320, one or more memories 1360, a GNSS receiver 1380, and/or other components of a GNSS device 1300, as illustrated in FIG. 13.

The functionality at block 1230 comprises determining final integer ambiguity values for the set of epochs based at least in part on an analysis of the first set of rounded values for the set of epochs. The final integer ambiguity values, which may be determined using Algorithms 1, 2, or 3, for example, may comprise values used for position determination of the GNSS device, and may provide correction for any cycle slips that may have occurred, as described in the embodiments herein. According to some embodiments, the first set of rounded values for the float ambiguity values may be based on a rounded value for an epoch in the set of epochs occurring first in time. In such embodiments, the analysis of the first set of rounded values a comprise determining at least one non-zero offset between the first set of rounded values and a second set of rounded values comprising one or more second rounded values for the float ambiguity values based on a rounded value for an epoch in the set of epochs occurring last in time; and determining the final integer ambiguity values based on an evaluation of the at least one non-zero offset between the first set of rounded values and the second set of rounded values. As described above with respect to FIGS. 6 and 7, this functionality may be implemented in Algorithm 1 or Algorithm 2, for example. In such embodiments, the final integer ambiguity values for all epochs in the set of epochs may comprise the first set of rounded values or the second set of rounded values. As further noted, according to Algorithm 2, different subsets of continuous epochs may be analyzed based on having a common non-zero offset. Thus, according to some embodiments of the method 1200, the at least one non-zero offset may comprise two or more non-zero offsets, each subset of two or more subsets of continuous epochs within the set of epochs may comprise a respective non-zero offset, and determining the final integer ambiguity values may comprise determining the final integer ambiguity values for each subset of the two or more subsets. Further, as noted at blocks 650 and 750 of FIGS. 6 and 7, final integer ambiguity values may be based on an evaluation of Diff 1 and Diff 2. As such, according to some embodiments of the method 1200, the evaluation of the at least one non-zero offset between the first set of rounded values and the second set of rounded values may comprise determining a first difference value comprising a difference between mean value of the first set of rounded values and the mean value of rounding results for each epoch, determining a second difference value comprising a difference between mean value of the second set of rounded values and the mean value of the rounding results for each epoch, and evaluating whether the first difference value is less than the second difference value.

Additionally or alternatively, embodiments may implement Algorithm 3, in which an evaluation of rounding values is made. For example, according to some embodiments, the analysis of the first set of rounded values for the set of epochs a comprise determining a most common rounding value for the float ambiguity values, and determining whether one or more float ambiguity values have a corresponding rounding value other than the most common rounding value. In such embodiments, determining the final integer ambiguity values for the set of epochs may comprise setting the final integer ambiguity values for the set of epochs as the most common rounding value if a number of the one or more float ambiguity values with a corresponding rounding value other than the most common rounding value is less than a threshold. According to some embodiments, determining the final integer ambiguity values for the set of epochs may comprise setting the final integer ambiguity values for the set of epochs based on a result of a statistical significance between the most common rounding value and a second most common rounding value if a number of the one or more float ambiguity values with a corresponding rounding value other than the most common rounding value is not less than a threshold.

Means and/or structure for performing functionality at block 1230 may comprise a bus 1305, one or more processors 1310, a digital signal processor 1320, one or more memories 1360, a GNSS receiver 1380, and/or other components of a GNSS device 1300, as illustrated in FIG. 13.

FIG. 13 is a block diagram of an embodiment of a GNSS device 1300, which can be utilized as described herein above (e.g., in association with FIGS. 1-12). In some embodiments, GNSS device 1300 may implement a positioning engine (e.g., a PPE) that can perform some or all of the functionality of the method 1200 of FIG. 12 and/or operations of one or more of FIGS. 1-8. It should be noted that FIG. 13 is meant only to provide a generalized illustration of various components, any or all of which may be utilized as appropriate. It can be noted that, in some instances, components illustrated by FIG. 13 can be localized to a single physical device and/or distributed among various networked devices, which may be disposed at different physical locations (and in which case a GNSS position may be determined for the GNSS receiver 1380). Furthermore, the GNSS device 1300 may be incorporated into another device, such as a cell phone, vehicle, etc., as previously noted.

The GNSS device 1300 is shown comprising hardware elements that can be electrically coupled via a bus 1305 (or may otherwise be in communication, as appropriate). The hardware elements may include a processor(s) 1310 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1310 may comprise one or more processing units, which may be housed in a single integrated circuit (IC) or multiple ICs. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below). The GNSS device 1300 also can include one or more input devices 1370, which can include without limitation one or more keyboards, touch screens, touch pads, microphones, buttons, dials, switches, and/or the like; and one or more output devices 1315, which can include without limitation one or more displays (e.g., touch screens), light emitting diodes (LEDs), speakers, and/or the like.

The GNSS device 1300 may also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 1300 to communicate with other devices as described in the embodiments above. The wireless communication interface 1330 may permit data and signaling to be communicated (e.g., transmitted and received) with base stations of a network, for example, via eNBs, gNBs, ng-eNBs, access points, and/or other access node types, and/or other network components, computer systems, and/or any other electronic devices communicatively coupled with base stations, as described herein. The communication can be carried out via one or more wireless communication antenna(s) 1332 that send and/or receive wireless signals 1334. According to some embodiments, the wireless communication antenna(s) 1332 may comprise a plurality of discrete antennas, antenna arrays, or any combination thereof. The antenna(s) 1332 may be capable of transmitting and receiving wireless signals using beams (e.g., Tx beams and Rx beams). Beam formation may be performed using digital and/or analog beam formation techniques, with respective digital and/or analog circuitry. The wireless communication interface 1330 may include such circuitry.

Depending on desired functionality, the wireless communication interface 1330 may comprise a separate receiver and transmitter, or any combination of transceivers, transmitters, and/or receivers to communicate with base stations (e.g., ng-eNBs and gNBs) and/or other terrestrial transceivers, such as wireless devices and access points. The GNSS device 1300 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 1300 can further include sensor(s) 1340. Sensor(s) 1340 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 1300 may also include a Global Navigation Satellite System (GNSS) receiver 1380 capable of receiving signals 1384 from one or more GNSS satellites using an antenna 1382 (which could be the same as antenna 1332). Positioning based on GNSS signal measurement can be utilized to complement and/or incorporate the techniques described herein. The GNSS receiver 1380 can extract a position of the GNSS device 1300, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1380 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1380 is illustrated in FIG. 13 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1310, DSP 1320, and/or a processor within the wireless communication interface 1330 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1310 or DSP 1320.

The GNSS device 1300 may further include and/or be in communication with a memory 1360. The memory 1360 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the GNSS device 1300 also can comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the GNSS device 1300 (and/or processor(s) 1310 or DSP 1320 within GNSS device 1300). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1: A method of global navigation satellite system (GNSS) positioning of a GNSS device, the method comprising: determining that preliminary conditions are met for a set of epochs comprising a plurality of successive epochs having float ambiguity values for carrier phase measurements taken by the GNSS device, wherein the preliminary conditions comprise: the set of epochs is a continuous series of epochs for which one or more time increments between epochs occur at an expected interval, and a single reference satellite is used by the GNSS device to determine the float ambiguity values of the set of epochs; responsive to determining the preliminary conditions are met, determining a first set of rounded values comprising one or more first rounded values for the float ambiguity values; and determining final integer ambiguity values for the set of epochs based at least in part on an analysis of the first set of rounded values for the set of epochs.
Clause 2: The method of clause 1 wherein: the first set of rounded values for the float ambiguity values are based on a rounded value for an epoch in the set of epochs occurring first in time; and the analysis of the first set of rounded values comprises: determining at least one non-zero offset between the first set of rounded values and a second set of rounded values comprising one or more second rounded values for the float ambiguity values based on a rounded value for an epoch in the set of epochs occurring last in time; and determining the final integer ambiguity values based on an evaluation of the at least one non-zero offset between the first set of rounded values and the second set of rounded values.
Clause 3: The method of clause 2, wherein the final integer ambiguity values for all epochs in the set of epochs comprise the first set of rounded values or the second set of rounded values.
Clause 4: The method of any one of clauses 2-3, wherein: the at least one non-zero offset comprises two or more non-zero offsets; each subset of two or more subsets of continuous epochs within the set of epochs comprises a respective non-zero offset; and determining the final integer ambiguity values comprises determining the final integer ambiguity values for each subset of the two or more subsets.
Clause 5: The method of any one of clauses 2-4, wherein the evaluation of the at least one non-zero offset between the first set of rounded values and the second set of rounded values comprises: determining a first difference value comprising a difference between mean value of the first set of rounded values and the mean value of rounding results for each epoch, determining a second difference value comprising a difference between mean value of the second set of rounded values and the mean value of the rounding results for each epoch, and evaluating whether the first difference value is less than the second difference value.
Clause 6: The method of clause 1, wherein the analysis of the first set of rounded values for the set of epochs comprises: determining a most common rounding value for the float ambiguity values; and determining whether one or more float ambiguity values have a corresponding rounding value other than the most common rounding value.
Clause 7: The method of clause 6, wherein determining the final integer ambiguity values for the set of epochs comprises setting the final integer ambiguity values for the set of epochs as the most common rounding value if a number of the one or more float ambiguity values with a corresponding rounding value other than the most common rounding value is less than a threshold.
Clause 8: The method of any one of clauses 6-7, wherein determining the final integer ambiguity values for the set of epochs comprises setting the final integer ambiguity values for the set of epochs based on a result of a statistical significance between the most common rounding value and a second most common rounding value if a number of the one or more float ambiguity values with a corresponding rounding value other than the most common rounding value is not less than a threshold.
Clause 9: A global navigation satellite system (GNSS) device comprising: at least one GNSS receiver; at least one memory; and at least one processor communicatively coupled with the at least one GNSS receiver and at least one memory, the at least one processor configured to: determine that preliminary conditions are met for a set of epochs comprising a plurality of successive epochs having float ambiguity values for carrier phase measurements taken using the at least one GNSS receiver, wherein the preliminary conditions comprise: the set of epochs is a continuous series of epochs for which one or more time increments between epochs occur at an expected interval, and a single reference satellite is used by the GNSS device to determine the float ambiguity values of the set of epochs; responsive to determining the preliminary conditions are met, determine a first set of rounded values comprising one or more first rounded values for the float ambiguity values; and determine final integer ambiguity values for the set of epochs based at least in part on an analysis of the first set of rounded values for the set of epochs.
Clause 10: The device of clause 9, wherein the at least one processor is further configured to: base the first set of rounded values for the float ambiguity values on a rounded value for an epoch in the set of epochs occur first in time; and perform the analysis of the first set of rounded values, the analysis of the first set of rounded values comprising: determining at least one non-zero offset between the first set of rounded values and a second set of rounded values comprising one or more second rounded values for the float ambiguity values based on a rounded value for an epoch in the set of epochs occurring last in time; and determining the final integer ambiguity values based on an evaluation of the at least one non-zero offset between the first set of rounded values and the second set of rounded values.
Clause 11: The device of clause 10, wherein the final integer ambiguity values for all epochs in the set of epochs comprise the first set of rounded values or the second set of rounded values.
Clause 12: The device of any one of clauses 10-11, wherein: the at least one non-zero offset comprises two or more non-zero offsets; each subset of two or more subsets of continuous epochs within the set of epochs comprises a respective non-zero offset; and determine the final integer ambiguity values comprises determining the final integer ambiguity values for each subset of the two or more subsets.
Clause 13: The device of any one of clauses 10-12, wherein, to perform the evaluation of the at least one non-zero offset between the first set of rounded values and the second set of rounded values, the at least one processor is configured to: determine a first difference value comprising a difference between mean value of the first set of rounded values and the mean value of rounding results for each epoch; determine a second difference value comprising a difference between mean value of the second set of rounded values and the mean value of the rounding results for each epoch, and; and evaluate whether the first difference value is less than the second difference value.
Clause 14: The device of clause 9, wherein the at least one processor is configured to perform the analysis of the first set of rounded values, the analysis of the first set of rounded values comprising: determining a most common rounding value for the float ambiguity values; and determining whether one or more float ambiguity values have a corresponding rounding value other than the most common rounding value.
Clause 15: The device of clause 14, wherein, to determine the final integer ambiguity values for the set of epochs, the at least one processor is configured to set the final integer ambiguity values for the set of epochs as the most common rounding value if a number of the one or more float ambiguity values with a corresponding rounding value other than the most common rounding value is less than a threshold.
Clause 16: The device of any one of clauses 14-15, wherein, to determine the final integer ambiguity values for the set of epochs, the at least one processor is configured to set the final integer ambiguity values for the set of epochs based on a result of a statistical significance between the most common rounding value and a second most common rounding value if a number of the one or more float ambiguity values with a corresponding rounding value other than the most common rounding value is not less than a threshold.
Clause 17: A device for global navigation satellite system (GNSS) positioning, the device comprising: means for determining that preliminary conditions are met for a set of epochs comprising a plurality of successive epochs having float ambiguity values for carrier phase measurements taken by a GNSS device, wherein the preliminary conditions comprise: the set of epochs is a continuous series of epochs for which one or more time increments between epochs occur at an expected interval, and; a single reference satellite is used by the GNSS device to determine the float ambiguity values of the set of epochs; means for, responsive to determining the preliminary conditions are met, determining a first set of rounded values comprising one or more first rounded values for the float ambiguity values; and means for determining final integer ambiguity values for the set of epochs based at least in part on an analysis of the first set of rounded values for the set of epochs.
Clause 18: The device of clause 17, wherein the first set of rounded values for the float ambiguity values are based on a rounded value for an epoch in the set of epochs occurring first in time, the device further comprising: means for performing the analysis of the first set of rounded values, the means for performing the analysis of the first set of rounded values comprising: means for determining at least one non-zero offset between the first set of rounded values and a second set of rounded values comprising one or more second rounded values for the float ambiguity values based on a rounded value for an epoch in the set of epochs occurring last in time; and means for determining the final integer ambiguity values based on an evaluation of the at least one non-zero offset between the first set of rounded values and the second set of rounded values.
Clause 19: The device of clause 18, wherein the final integer ambiguity values for all epochs in the set of epochs comprise the first set of rounded values or the second set of rounded values.
Clause 20: The device of clause 17, further comprising means for performing the analysis of the first set of rounded values for the set of epochs, the means for performing the analysis comprising: means for determining a most common rounding value for the float ambiguity values; and means for determining whether one or more float ambiguity values have a corresponding rounding value other than the most common rounding value.

What is claimed is:

1. A method of global navigation satellite system (GNSS) positioning of a GNSS device, the method comprising:
determining that preliminary conditions are met for a set of epochs comprising a plurality of successive epochs having float ambiguity values for carrier phase measurements taken by the GNSS device, wherein the preliminary conditions comprise:
the set of epochs is a continuous series of epochs for which one or more time increments between epochs occur at an expected interval, and
a single reference satellite is used by the GNSS device to determine the float ambiguity values of the set of epochs;
responsive to determining the preliminary conditions are met, determining a first set of rounded values comprising one or more first rounded values for the float ambiguity values; and
determining final integer ambiguity values for the set of epochs based at least in part on an analysis of the first set of rounded values for the set of epochs.

2. The method of claim 1 wherein:
the first set of rounded values for the float ambiguity values are based on a rounded value for an epoch in the set of epochs occurring first in time; and
the analysis of the first set of rounded values comprises:
determining at least one non-zero offset between the first set of rounded values and a second set of rounded values comprising one or more second rounded values for the float ambiguity values based on a rounded value for an epoch in the set of epochs occurring last in time; and
determining the final integer ambiguity values based on an evaluation of the at least one non-zero offset between the first set of rounded values and the second set of rounded values.

3. The method of claim 2, wherein the final integer ambiguity values for all epochs in the set of epochs comprise the first set of rounded values or the second set of rounded values.

4. The method of claim 2, wherein:
the at least one non-zero offset comprises two or more non-zero offsets;
each subset of two or more subsets of continuous epochs within the set of epochs comprises a respective non-zero offset; and
determining the final integer ambiguity values comprises determining the final integer ambiguity values for each subset of the two or more subsets.

5. The method of claim 2, wherein the evaluation of the at least one non-zero offset between the first set of rounded values and the second set of rounded values comprises:
determining a first difference value comprising a difference between mean value of the first set of rounded values and the mean value of rounding results for each epoch,
determining a second difference value comprising a difference between mean value of the second set of rounded values and the mean value of the rounding results for each epoch, and
evaluating whether the first difference value is less than the second difference value.

6. The method of claim 1, wherein the analysis of the first set of rounded values for the set of epochs comprises:
determining a most common rounding value for the float ambiguity values; and
determining whether one or more float ambiguity values have a corresponding rounding value other than the most common rounding value.

7. The method of claim 6, wherein determining the final integer ambiguity values for the set of epochs comprises setting the final integer ambiguity values for the set of epochs as the most common rounding value if a number of the one or more float ambiguity values with a corresponding rounding value other than the most common rounding value is less than a threshold.

8. The method of claim 6, wherein determining the final integer ambiguity values for the set of epochs comprises setting the final integer ambiguity values for the set of epochs based on a result of a statistical significance between the most common rounding value and a second most common rounding value if a number of the one or more float ambiguity values with a corresponding rounding value other than the most common rounding value is not less than a threshold.

9. A global navigation satellite system (GNSS) device comprising:
at least one GNSS receiver;
at least one memory; and
at least one processor communicatively coupled with the at least one GNSS receiver and at least one memory, the at least one processor configured to:
determine that preliminary conditions are met for a set of epochs comprising a plurality of successive epochs having float ambiguity values for carrier phase measurements taken using the at least one GNSS receiver, wherein the preliminary conditions comprise:
the set of epochs is a continuous series of epochs for which one or more time increments between epochs occur at an expected interval, and
a single reference satellite is used by the GNSS device to determine the float ambiguity values of the set of epochs;
responsive to determining the preliminary conditions are met, determine a first set of rounded values comprising one or more first rounded values for the float ambiguity values; and
determine final integer ambiguity values for the set of epochs based at least in part on an analysis of the first set of rounded values for the set of epochs.

10. The device of claim 9, wherein the at least one processor is further configured to:
base the first set of rounded values for the float ambiguity values on a rounded value for an epoch in the set of epochs occur first in time; and
perform the analysis of the first set of rounded values, the analysis of the first set of rounded values comprising:
determining at least one non-zero offset between the first set of rounded values and a second set of rounded values comprising one or more second rounded values for the float ambiguity values based on a rounded value for an epoch in the set of epochs occurring last in time; and
determining the final integer ambiguity values based on an evaluation of the at least one non-zero offset between the first set of rounded values and the second set of rounded values.

11. The device of claim 10, wherein the final integer ambiguity values for all epochs in the set of epochs comprise the first set of rounded values or the second set of rounded values.

12. The device of claim 10, wherein:
the at least one non-zero offset comprises two or more non-zero offsets;
each subset of two or more subsets of continuous epochs within the set of epochs comprises a respective non-zero offset; and
determine the final integer ambiguity values comprises determining the final integer ambiguity values for each subset of the two or more subsets.

13. The device of claim 10, wherein, to perform the evaluation of the at least one non-zero offset between the first set of rounded values and the second set of rounded values, the at least one processor is configured to:
determine a first difference value comprising a difference between mean value of the first set of rounded values and the mean value of rounding results for each epoch;
determine a second difference value comprising a difference between mean value of the second set of rounded values and the mean value of the rounding results for each epoch, and; and
evaluate whether the first difference value is less than the second difference value.

14. The device of claim 9, wherein the at least one processor is configured to perform the analysis of the first set of rounded values, the analysis of the first set of rounded values comprising:
determining a most common rounding value for the float ambiguity values; and
determining whether one or more float ambiguity values have a corresponding rounding value other than the most common rounding value.

15. The device of claim 14, wherein, to determine the final integer ambiguity values for the set of epochs, the at least one processor is configured to set the final integer ambiguity values for the set of epochs as the most common rounding value if a number of the one or more float ambiguity values with a corresponding rounding value other than the most common rounding value is less than a threshold.

16. The device of claim 14, wherein, to determine the final integer ambiguity values for the set of epochs, the at least one processor is configured to set the final integer ambiguity values for the set of epochs based on a result of a statistical significance between the most common rounding value and a second most common rounding value if a number of the one or more float ambiguity values with a corresponding rounding value other than the most common rounding value is not less than a threshold.

17. A device for global navigation satellite system (GNSS) positioning, the device comprising:
means for determining that preliminary conditions are met for a set of epochs comprising a plurality of successive epochs having float ambiguity values for carrier phase measurements taken by a GNSS device, wherein the preliminary conditions comprise:
the set of epochs is a continuous series of epochs for which one or more time increments between epochs occur at an expected interval, and;
a single reference satellite is used by the GNSS device to determine the float ambiguity values of the set of epochs;
means for, responsive to determining the preliminary conditions are met, determining a first set of rounded values comprising one or more first rounded values for the float ambiguity values; and
means for determining final integer ambiguity values for the set of epochs based at least in part on an analysis of the first set of rounded values for the set of epochs.

18. The device of claim 17, wherein the first set of rounded values for the float ambiguity values are based on a rounded value for an epoch in the set of epochs occurring first in time, the device further comprising:
means for performing the analysis of the first set of rounded values, the means for performing the analysis of the first set of rounded values comprising:
means for determining at least one non-zero offset between the first set of rounded values and a second set of rounded values comprising one or more second rounded values for the float ambiguity values based on a rounded value for an epoch in the set of epochs occurring last in time; and
means for determining the final integer ambiguity values based on an evaluation of the at least one non-zero offset between the first set of rounded values and the second set of rounded values.

19. The device of claim 18, wherein the final integer ambiguity values for all epochs in the set of epochs comprise the first set of rounded values or the second set of rounded values.

20. The device of claim 17, further comprising means for performing the analysis of the first set of rounded values for the set of epochs, the means for performing the analysis comprising:
means for determining a most common rounding value for the float ambiguity values; and
means for determining whether one or more float ambiguity values have a corresponding rounding value other than the most common rounding value.
